(19) United States
(12) Patent Application Publication
(10) Pub. No.: US 2005/0112371 A1
(43) Pub. Date: May 26, 2005

(54) Microporous hollow fiber membrane with lengthwise variable mechanical and filtration properties and the method of their preparation

(76) Inventors: Milan Plesek, Zlin (CZ); Miroslav Luen, Zlin (CZ); Mirko Dohnal, Ostopovice (CZ)

Correspondence Address: DONN K. HARMS;PATENT & TRADEMARK LAW CENTER, SUITE 100, 12702 VIA CORTINA, DEL MAR, CA, 92014, US

(21) Appl. No.: 10/501,585

(22) PCT Filed: Jan. 9, 2003
(86) PCT No.: PCT/CZ03/00001

(30) Foreign Application Priority Data
Jan. 16, 2002 (CZ) PV2002-184

(51) Int. Cl. B32B 3/26; D02G 3/00

(52) U.S. Cl. 428/359; 428/304.4; 428/364

(57) ABSTRACT

The microporous hollow fiber membrane is formed by walls with a system of slit-like micropores oriented in a lengthwise direction showing constant size and density of the micropores across the fiber and variable size and density along the fiber length such that the size and the density of the pores are lower towards the fiber ends. The invention also includes the method of preparation of the hollow microporous membrane fiber.

### FIELD OF INVENTION

Disclosed is a microporous hollow fiber membrane with mechanical physical and filtration properties that vary along the length of the fiber from the high filtration capacity of the middle section to the increased toughness of the end sections. This hollow fiber in the form of bundles, curtains or other arrangements can be used for the filtration of liquids and gases or for other membrane applications.

### BACKGROUND ART

The porous structures in the hollow fiber of crystalline polymers results from the extension of the “precursor”, i.e. nonporous fiber, in which a special crystalline structure develops during the spinning process. The structure, defined as “hard elastic”, is unique not only for its extreme elasticity of fibers and the films containing it, but also for its ability to form microporous structures by extension beyond a specific limit. The mechanism of the hard elastic structure development has been studied and described in many publications of the 1960s and 1970s. A good example is Samuels' paper describing in detail the preparation conditions required for the manufacture of polypropylene fiber with a high content of hard elastic structure, the effect of subsequent thermal treatment on the level of fiber elasticity, the relationship between the total volume of the pores on the extension at room temperature and other findings, including a theoretical explanation of the observed phenomena. The author also described the effect of thermal treatment on fiber extended at room temperature and exposed to high temperatures in the fixed extended form, pointing to the fact that fiber thus prepared have very high strength. The above-mentioned work, plus many others, mainly focused on the possibility of preparing polymeric fiber with excellent mechanical properties, with the development of microvoids considered as a rather negative side effect. It has also been pointed out that similar behavior is also shown not only by polypropylene but also by other polymers such as polyethylene, poly-methyl-pentene, poly-butene and others.

Together with the development of a highly elastic fiber attention was also paid to the practical application of the micropores resulting from the extension of the polymers containing a hard elastic structure, i.e. to the preparation of polymeric membranes. The basic principle of preparing microporous membranes by the application of the technology of stretching was first described in U.S. Pat. No. 3,558,764, specifying the method of microporous film preparation from non-porous polypropylene or other crystalline polymeric films by stretching. In the 1970s further details of the technology were developed and patented.

A similar mechanism of pore development in the hollow fiber of polypropylene using the extension method was first mentioned in U.S. Pat. No. 4,055,696 (Kamada et al. of Mitsubishi Rayon). A similar procedure of membrane preparation from polyethylene was patented by Shindo et al., in U.S. Pat. No. 4,405,688 and U.S. Pat. No. 4,541,981. Hollow microporous fiber with extremely large pores and high porosity made of polyethylene and polypropylene was described in U.S. Pat. No. 5,294,338 and U.S. Pat. No. 5,547,756. On the other hand, hollow fiber with very small pores and high pore density was described in U.S. Pat. No. 5,013,439.

All of the above-mentioned patents are based on the method of extension of the fiber or film containing the hard elastic structure where the pores are developed in two stages: cold extension at room temperature, or at a temperature below 370 K, and hot extension, at a temperature quite close to the melting point of the given polymer. In all cases the process of porous structure development is described as continual, with the developing hollow porous fiber or film showing homogenous parameters in the direction of the extension. The fiber or film precursor is unwound from the coil, exposed to cold and hot extension and then wound on the coil again. Further unwinding then leads to the formation of bundles or curtains, and these bundles or curtains can then be used for the preparation of various types of modules applicable to the filtration of liquids and gases or other membrane applications.

The most frequently applied filtration applications is the so-called submerged systems (tank-submerged type membrane filtration) when bundles or curtains of hollow fiber are freely submerged into a tank containing the contaminated liquid. The bundles of fibers are provided with suitable endings at one or both ends, which enable the liquid to be sucked from the inside hollows of the fiber, where it penetrates through the porous walls. A sucking pump or low pressure evoked by gravitation sucks the purified liquid from inside the hollows of the fiber while the dirt remains outside. For the dirt not to stick to the surface of the fibers, they are subjected to various methods of agitation, i.e. forced movement to make the dirt particles fall off. There are several different methods of initiating the agitation, including for example periodical mechanical enforced oscillation of the bundle ends, intense flow of the liquid or exposure of the fiber to a stream of coarse air bubbles. Agitation must be intensive enough to ensure long-term filtration without a significant blocking of the pores. Each of the above-mentioned agitation processes brings a mechanical stress in the fibers, especially near the ends. The stress may be so heavy that the mechanical strength of the fiber may be exceeded. The fiber toughness generally decreases significantly with increasing porosity. Similarly strong is the effect of porosity on the hollow fiber resistance against low-radius bends, called kink resistance. The hydrodynamic forces of very strong agitation may cause such sharp bends in the fiber that the membrane may became damaged, and even a fissure or tearing of the fiber may occur. Such damage to the membrane may cause a failure of the filtration elements. For those reasons no freely high level of aggressive agitation can be used on membranes of a constantly high porosity. At the same time, however, high porosity is desirable for the achievement of high specific filtration performance or through flow, determining the economy of the filtration process. These are contradictory requirements and therefore a certain compromise has had to be made so far.

### NATURE OF THE INVENTION

The above-mentioned disadvantages of the current types of microporous hollow fiber are to a great extent eliminated by this newly invented microporous hollow fiber membrane with lengthwise variable mechanical and filtration properties and the method of its preparation. The essence of the invention is as follows: the hollow fiber formed by the walls with a system of slit-shaped micropores oriented in a lengthwise direction shows a size and density of micropores constant across the fiber and a variable along the fiber length such that the size and the density of the pores are lower towards the fiber ends.

The invented microporous hollow fiber membrane presents a central section porosity of 20-90%, with the advantage of 40-60%, and an end section porosity of 10-50%, with the advantage of 20-40%. The central section with the high porosity is 0.1-10 m long, with the advantage of 0.5-2 m, with the end sections of lower porosity 0.02-0.5 m long, with the advantage of 0.1-0.2 m.

The microporous hollow fiber membrane is made usually of polyolefins, mainly of polyethylene, polypropylene or their mixtures.

The essence of the method of preparation of microporous hollow fiber membrane is as follows: spinning of the polymer melt results in a non-porous hollow fiber—the precursor, annealed in the non-extended state at a temperature no lower than 40 K below the polymer melting point for at least 0.5 h. At normal temperature the fiber is extended by 7 to 50% at a speed of at least 20% per minute, and then follows extension at the normal or higher temperature in a chamber which enables the lengthwise periodical thermal shielding of the fiber in chosen places by at least −2K, at a speed of up to 50% per minute. The resulting product is stabilised at a temperature lower or equal to the temperature of the thermal shielding. After that, the fiber is cut in the places of the thermal shielding and the parallel arrangement of the cuts forms bundles or curtains.

The fiber is arranged into bundles or curtains as follows: Around the ends each fiber shows less porosity and smaller pores as the result of thermal shielding and lower extension, which means higher mechanical resistance to damage resulting from wear, or against potential breaking. The stronger the above-mentioned agitation during the course of the filtration process the more accentuated is this effect, for the fiber is exposed to the strongest mechanical stress at the end sections. The remaining substantial part of the fiber length possesses higher porosity and larger pores. A filtration element of such quality may therefore show high performance or high through flow and at the same time be resistant to mechanical damage or breaking because of wear at the fiber ends. The “L” length of the middle section of the fiber of high porosity may be modified to the “l” length of the end section of lower porosity depending on the length interval of the thermal shielding, which gives the possibility of length variability of the construction of the filtration modules, bundles or curtains with preserved NCP (non-constant porous) principle, which is the essence of the invention. The newly invented method of preparation of microporous hollow fiber membrane with NCP can include extension of HDPE hollow fiber at normal room temperature, if the extension speed is very low and the places of lower porosity are cooled to a temperature lower than the surrounding temperature.

The method of microporous hollow fiber membrane preparation, which is the basis of the invention, can be applied to any polymer, or a mixture of polymers, capable of hard elastic structure development, i.e. not only polyethylene and polypropylene, but also poly-methyl-pentane and others. The preparation of hollow fiber membrane with unequal porosity along its length (NCP) is based on the finding that the size of the pores and porosity developing during the course of the extension are strongly dependent not only on the overall degree of extension but also on the temperature. The places where the lowered temperature is kept show a lower porosity and therefore higher mechanical resistance. This sensitiveness to a decrease in local temperature is different for different polymers, significantly higher with HDPE and lower with PP. These differences are related to the different behavior of the polymers during the course of the extension process, i.e. to the varied sloping of their stress-strain curves made under different temperature exposure.

The main asset of the invented solution of NCP hollow fiber membrane is not only the elimination of the principal negative feature of constantly porous fiber—the necessity to seek optimum porosity and pore size with regard to the required aggressiveness of fiber agitation during the course of the filtration process, but also the acquisition of a very effective method of preparing filtration bundles, curtains or modules of required parameters without the necessity of adapting the manufacturing system. Simple setting of the initial and final period of repetition of the low porosity sections, selection of the temperature profile and the speed of extension allows the use of a single device for the preparation of NCP hollow fiber membrane of varied pore size and porosity and varied length of bundles of membranes subsequently made from the fiber, with the preserved advantage of the very resistant ends.

### EMBODIMENTS

The following methods of membrane property testing are used in the following embodiments:

Microscopy calibrated by means of the micrometric objective standard for measurement of the fiber diameter and thickness.

Volumetric method of determination of the volume of air passing through a 5 cm section of the membrane in a certain period of time that is sealed with wax into the end of a pressure hose with a blind opposite end of the membrane sample at air pressure of 50 or 100 kPa inside the fiber for air permeability measurement.

Real modules of 0.5 m2 total area of the inside surface submerged into a bowl of drinking water and sucked out at both ends with a centrifugal pump in the sucking mode based on the pressure of −75 kPa for water permeability measurement.

Simple practical test for kink resistance: a loop is made from a piece of the fiber by crossing its ends and tightened by pulling both ends over the raster with millimetre partitions. The criterion of resistance is the diameter of the loop at the moment when the fiber breaks down in a place.

### EXAMPLE 1

A HDPE precursor was prepared by extruding Borealis HE 8361 polymer (963 kg/m3 density, 0.5 melting index) at the material temperature of 210 degrees C. and extruder head temperature of 150 degrees C. through an opening of 4 mm diameter and a pin of 3.2 mm diameter without outside cooling at an outflow speed of 33 cm/min. The fiber was pulled off at the speed of 140 m/min and wound on a coil.

The resulting precursor outside diameter was 320 micro m and its wall thickness was 40 micro m.

The coil with the precursor was tempered for 12 hours at 120 degrees C.

A cold extension of 15% was performed at normal temperature at a speed of 35%/min.

A hot extension was performed in the following manner: the L section was extended at 75 degrees C. at a speed of 15%/min at a final extension ratio of 150%, while l section was kept at 70 degrees C.

The fixation was carried out at 70 degrees C. for 1 hour. After cutting and arranging the fiber sections a bundle of PE filtration membrane was formed, with an L section porosity of 55%, air permeability 130 l/m2 and a bend resistance of 16 mm, and an l section porosity of 37%, air permeability of 67 l/m2 and bend resistance of 2 mm. The pull tenacity of the fiber in both cases was 1.7N.

The length of the L section (filtration section) was 600 mm, and the length of the l section (anchoring section) was 100 mm. The bundle of 1,300 fiber sections was potted with PUR glue, which resulted in a filtration module of 750 mm in length and water permeability of 600 l/MHB.

### EXAMPLE 2

A PP precursor was prepared by extruding Mosten 58312 polymer (2.5 melting index) at the material temperature of 215 degrees C. and extruding head temperature of 205 degrees C. through an opening of 8 mm diameter and a pin of 7 mm diameter at an outflow speed of 14 cm/min.

The fiber was pulled off at a speed of 100 m/min and wound on a coil with the application of the minimum necessary pull. The coil with the precursor was tempered for 12 hours at 145 degrees C. A cold extension of 10% was performed at a speed of 35%/min. A hot extension was performed in the following manner: the L section was extended at 130 degrees C. at a speed of 5%/min at a final extension ratio of 150%, while the l section was kept at 120 degrees C.

The fixation was carried out at 120 degrees C. for 1 hour. After cutting and arranging the fiber sections a beam of PP membrane with a 295 micro m outside diameter was formed, with an L section porosity of 54%, air permeability of 95 l/m2 and bend resistance of 22 mm, and an l section porosity of 32%, air permeability of 39 l/m2 and bend resistance of 6 mm. The pull tenacity of the fiber in both cases was 2 N.

The length of the L section (filtration section) was 600 mm, and the length of the l section (anchoring section) was 120 mm. The bundle of 1,400 fiber sections was glued, which resulted in a filtration module of 750 mm in length and water permeability of 400 l/MHB.

### EXAMPLE 3

The precursor was prepared from a mixture of 80% HDPE Borealis HE 8361, 10% HDPE Mobil HMA 014 (964 kg/m3 density, 4 melting index) and 10% PP Mosten 58312 at the material temperature of 220 degrees C. and extruding head temperature of 175 degrees C. through an opening of 15 mm diameter and a pin of 11 mm diameter without outside cooling at an outflow speed of 4.2 cm/min. The fiber was pulled off at a speed of 55 m/min without outside cooling.

The outside diameter of the resulting precursor was 520 micro m and its wall thickness was 80 micro m. The coil with a precursor was tempered for 16 hours at 120 degrees C. A cold extension of 20% was performed at normal temperature at a speed of 50%/min.

Further extension was performed in the following manner: the L section was extended at a normal temperature of 23 degrees C. to a final extension ratio of 250%, at an extension speed of 0.003%/min, while the l section was kept at 20 degrees C. (the room temperature surrounding the process was 17 degrees C.).

After cutting and arranging the membrane and its size stabilization, a bundle of polyolefin membrane of 460 micro m diameter was formed, with an L section porosity of 46%, air permeability 68 l/m2 and bend resistance of 32 mm, and an l section porosity of 32%, air permeability of 27 l/m2 and bend resistance of 14 mm. The pull tenacity of the fiber was 5N. The length of the L section was 1,800 mm, and the length of the l section was 150 mm.

The bundle of 500 fiber sections was potted, which resulted in a filtration module of 2,000 mm in length and water permeability of 350 l/MHB.

### EXAMPLE 4

A polyolefin precursor was prepared under the same conditions as in example 3, with the following variance: the mixture of polyolefins was mixed with titanium white TiO2 of the rutile type with very fine particles (declared 0.23 micro m) in a concentration of 0.7% by weight. The other conditions of the precursor preparation remained unchanged.

The outside diameter of the resulting precursor was 540 micro m and its wall thickness was 80 micro m.

The coil with the precursor was tempered for 12 hours at 120 degrees C.

A cold extension of 20% was performed at normal temperature. A hot extension with a total extension ratio of 300% was performed in the following manner: the L section was kept at 85 degrees C. and the l section at 80 degrees C.

The fixation was carried out at 80 degrees C. for 30 minutes. The resulting bundle of 400 fiber sections had an L section porosity of 58%, and air permeability of 124 l/m2, and an l section porosity of 41%, and air permeability of 76 l/m2. The pull tenacity of the fiber was 4N.

The length of the L section was 1,500 mm, and the length of the l section was 120 mm.

The filtration module 1,600 mm in length had water permeability of 900 l/MHB.

1. A microporous hollow fiber membrane having variable mechanical and filtration properties in the lengthwise direction, the said microporous hollow fiber membrane being formed by walls possessing a system of slit-like lengthwise oriented micropores characterized in that size and density of the micropores are constant across the fiber and variable along the length of the fiber, the size and density of the said micropores decreasing towards the fiber ends.

2. A microporous hollow fiber membrane as claimed in claim 1, wherein the porosity is 20-90%, preferably 40-60%, in the middle section and 10-50%, preferably 20-40%, in the end sections.

3. A microporous hollow fiber membrane according to claim 1, in which the length is 0.1-10 m, preferably 0.5-2 m, in the middle section and 0.02-0.5 m, preferably 0.1-0.2 m, in the end sections.

4. A microporous hollow fiber membrane according to claim 1, in which polyolefin material, mainly polypropylene and polyethylene, or a blend of the two, is used to make the said fiber.

5. A method of preparation of a microporous hollow fiber membrane as claimed in claim 1, in which a hollow non-porous fiber—the precursor—is prepared by spinning the polymer melt, the said precursor being annealed in the unextended condition at a temperature not lower than 40 K below the polymer melting point for at least 0.5 hours, the fiber being extended by 7 to 50% at a speed of at least 20% per minute at the normal temperature, followed by an extension at the normal or higher temperature in a chamber permitting lengthwise periodical thermal shielding of the fiber by at least −2 K, the said extension proceeding at a speed of up to 50% per minute, the resulting product being stabilised at a temperature lower than or equal to the temperature of the thermal shielding, the fiber being subsequently cut in places of the thermal shielding and paralleled, most frequently into bundles or curtains.
